(19) United States
(12) Patent Application Publication
(10) Pub. No.: US 2016/0031129 A1
(43) Pub. Date: Feb. 4, 2016

(54) Method to produce a make-up cosmetic product

(71) Applicant: CHROMAVIS S.p.A., MILANO (IT)

(72) Inventor: Nicolò LARCERI, MILANO (IT)

(21) Appl. No.: 14/809,335

(22) Filed: Jul. 27, 2015

(30) Foreign Application Priority Data
Jul. 31, 2014 (IT) MI2014A001407

(51) Int. Cl. B29C 43/14; A45D 40/00; A45D 33/18

(52) U.S. Cl. CPC B29C 43/146; A45D 33/18; A45D 40/0068; A45D 2040/0012; B29C 2043/147; B29L 2031/718

(57) ABSTRACT

A method of making a cosmetic make-up product involves
a. dispensing a base cosmetic paste on a support
b. pressing the base paste through a first heated mold at a temperature higher than 60° C. and provided with at least one relief adapted to create a groove in the base paste;
c. dispensing a second decorative cosmetic paste on top of the base cosmetic paste so as to completely cover it and so as to fill at least partially the groove created in the base cosmetic paste by the mold,
d. pressing with a second mold the base and the decorative cosmetic paste so as to make the pastes take a shape of the second mold, thus obtaining a semi-finished product
e. drying the semi-finished product
f. surface working the dried semi-finished product to remove the decorative cosmetic paste at least from those areas of the base cosmetic paste without grooves.

This application claims priority to Italian patent application N. MI2014A001407 filed on Jul. 31, 2014, the disclosure of which is incorporated herein by reference.

### TECHNICAL FIELD

The present invention relates to a production method cosmetic make-up product.

In particular, it relates to a method of making a cosmetic make-up product of the baked type, consisting of at least two make-up products with different features one from the other, such as different colors.

### BACKGROUND

As known, the cosmetics industry is always looking for new methods for producing cosmetic products decorated in such a way as to be very appealing to the target audience.

Patent EP2218436B1, of the same applicant, describes a method of making a cosmetic make-up product implemented using a mold provided with reliefs, used along with a template in which the mold reliefs penetrate to make grooves inside a base cosmetic. Thereafter such grooves are filled with a further decorative cosmetic product using an additional template.

A cosmetic product is thus obtained which is decorated with high definition patterns and with clear and accurate lines and contours.

However, the working method is particularly laborious and difficult to be used on a large scale.

Patent application EP2220959 A1, again of the same applicant, describes a method for making a cosmetic make-up product which consists in depositing a base cosmetic paste on a bottom, pressing it with a first mold that has a smooth surface, spreading a cosmetic powder on the surface of the base cosmetic paste and pressing the whole with a second mold provided with reliefs.

The semi-finished product is then manually cleaned by rubbing the product onto suitable abrasive sponges. With this technique, the decorative powder is pressed by the second mold into the cosmetic paste, especially in those areas where the reliefs of the second mold are present.

Also this technique provides good results. However, the decorative powder that is pressed by the mold reliefs to create the grooves in the underlying base is distributed in such grooves in an uneven manner and the amount that at the end of the process remains into the same is not fully satisfactory.

### SUMMARY

The object of the present invention is to provide a method of making a cosmetic make-up product which overcomes the technical drawbacks of the prior art.

More in particular, an object of the present invention is to provide a method of making a cosmetic make-up product which can be applied on an industrial scale and which ensures a good reproducibility and productivity.

Another object of the present invention is to provide a method able to make a cosmetic make-up product with very deep decorations, saturated with decorative cosmetic product and with a well-defined design.

This and other objects are achieved by a method implemented according to the technical teachings of the appended claims.

### BRIEF DESCRIPTION OF THE DRAWING FIGURES

Further features and advantages of the invention will become apparent from the description of a preferred but non-exclusive embodiment of the device, shown by way of a non-limiting example in the accompanying drawings, in which:

FIGS. 1 to 8 schematically show some steps of the process according to the present description;

FIG. 9 shows a cosmetic make-up product made according to the method in FIGS. 1-8; and

FIGS. 10 and 11 show alternative embodiments of the cosmetic make-up product.

### DETAILED DESCRIPTION

With reference to the above figures, a method of making a cosmetic make-up product is shown, indicated as a whole with reference numeral 1.

The first step of the method provides for dispensing a base cosmetic paste 2 on a support 3 which actually is the base (or bottom) for a cosmetic product.

The base cosmetic paste 2 may be dispensed by an automatic equipment; it preferably has a dynamic viscosity in the range between 800,000 and 1,500,000 cP at 25° C., so as to be rather dense.

The bottom or support 3 may be of any material and shape compatible with that of the molds that will be used later. In any case, it is preferable that the bottom, for a product like that shown, be made of terracotta and with a substantially circular shape.

The second step of the method provides for pressing the base paste 2 using a first mold 4 heated at a temperature higher than 60° C. The first mold is provided with a plurality of reliefs adapted to create grooves in the base paste 2 during pressing.

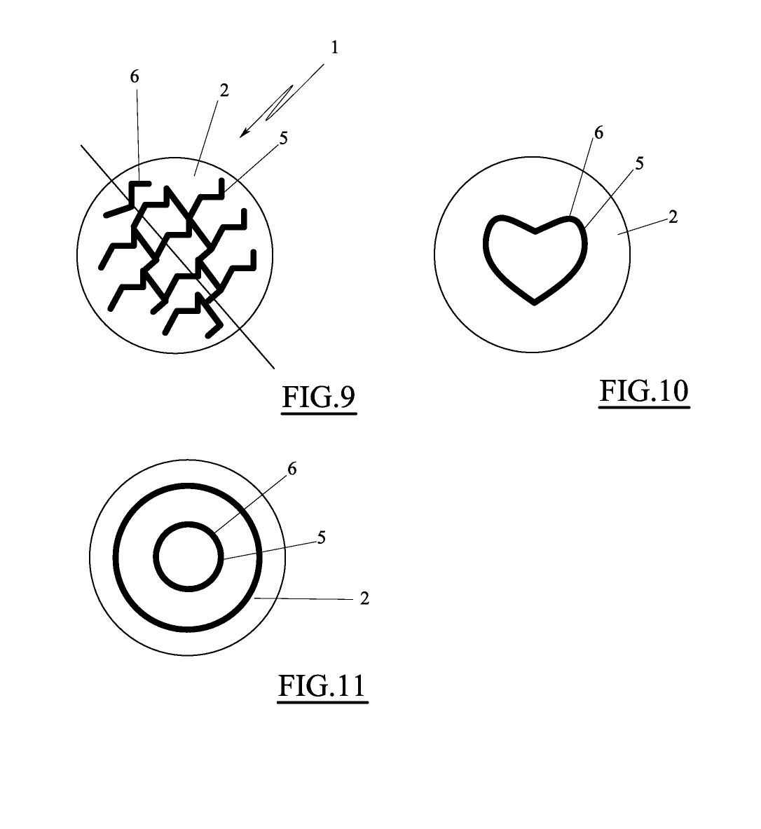

The reliefs may be arranged so as to create a pattern on the surface of the product, and in the case shown they are arranged so to represent a set of broken lines (see FIG. 9). Of course, they may have any shape or wording (such as a product brand). It must be said that the reliefs have a height h advantageously in the range between 1 and 4 mm, preferably 2.7 mm.

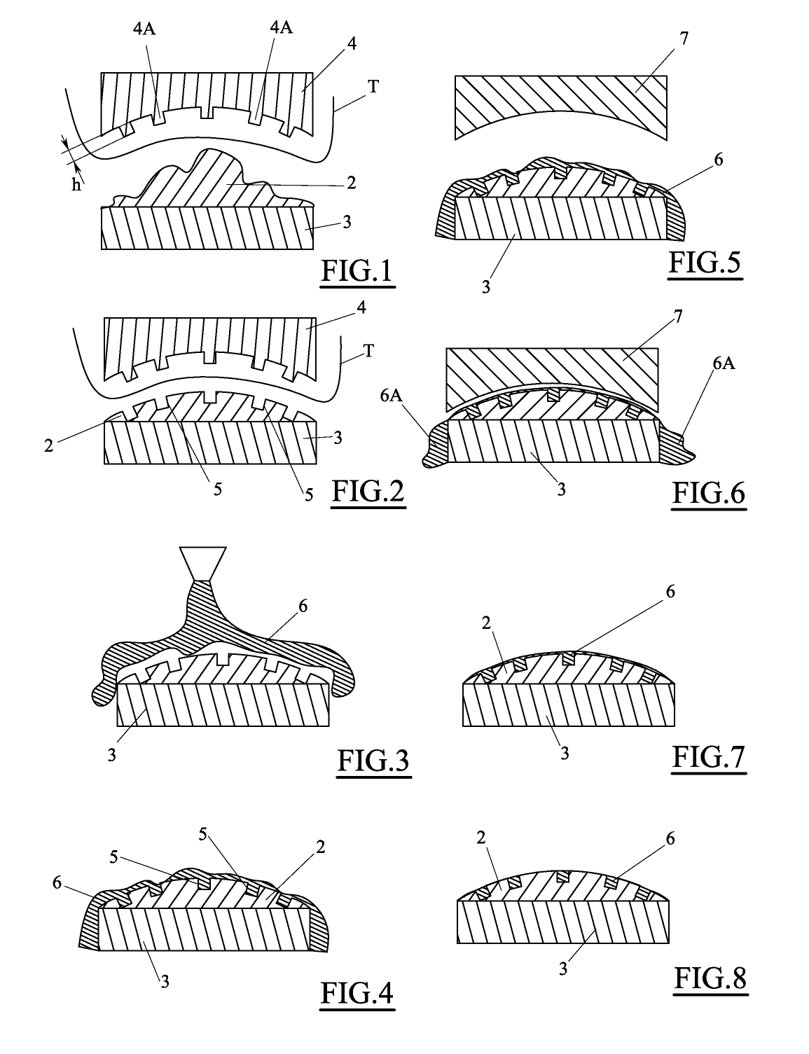

FIG. 1 shows a step in which mold 4 is about to close on the bottom to press the base paste 2 just dispensed.

FIG. 2 instead shows a step immediately following the opening of the mold.

It has been verified that the use of a hot mold allows obtaining perfectly defined grooves in the base cosmetic paste and that are able to have a much greater depth and definition compared to that obtained in a non-heated mold.

It is believed that this is due to the fact that hot mold makes the solvent present in the interface surface between the mold evaporate. The surface part therefore hardens immediately compared to the underlying one and thus is able to better retain the shape imposed by mold 4, and specifically by the reliefs thereof. In fact, perfectly defined grooves 5 with very clear edges appear into paste 2.

Another hypothesis is that by at least partially eliminating the solvent (making it evaporate) in the interface surface between mold and base paste 2, the hot mold promotes the detachment of the mold from the paste which actually occurs in a very sharp manner. In practice, the mold does not hold onto the base cosmetic paste 2 as it is lifted from the same, and this allows achieving excellent results in terms of definition and depth of the grooves.

Using a base cosmetic paste 2 in which the main solvent is water, it has been seen that it is preferable to use a temperature in the range between 90° C. and 120° C., but even better if the temperature is between 95° C. and 105° C. In this case, the optimal temperature is 100° C., which corresponds to the vaporization temperature of water (i.e. the main solvent of the base cosmetic paste 2) at atmospheric pressure.

Therefore, it is deemed that the optimal temperature for the mold is the boiling temperature of the main solvent used in the base cosmetic paste 2.

Advantageously, a canvas is interposed between mold 4 and the base cosmetic paste 2 before pressing the latter. The canvas is for example of the type produced by Nastri-tex company, of the soft type:
composition: 80% polyamide/20% elastane
surface density: 70 [g/m²]
thickness: 100 micron

The interposed canvas has a double function of at least partially absorbing the solvent that is squeezed from the paste during pressing and preventing any residues of cosmetic paste from adhering to the mold surface or obstructing the grooves.

The third step of the method, shown in FIG. 3, provides for dispensing a second decorative cosmetic paste 6 on top of the base cosmetic paste 2 worked at the preceding step, so as to cover it completely and so as to fill at least partly the grooves 5 made in the base cosmetic paste 2 by the hot mold 4.

To this end, the decorative paste 6 has a smoother texture than the base cosmetic paste 2, and in particular it has such a viscosity as to allow it to be regularly distributed in the grooves created by the pressure of the mold. For example, the viscosity is in the range between 300,000 and 500,000 cP, measured at 25° C.

FIG. 6 shows the step immediately following the pressing with a second mold 7 of the base cosmetic paste 2 and of the decorative paste 6 so as to make both take the shape of the second mold 7, thus obtaining a semi-finished product.

It is noted that the excess decorative paste 6, in this step, is discharged from the edges of the mold, which advantageously may have openings or passages intended precisely for that purpose.

Advantageously, the surface of the second mold 7 intended to contact the cosmetic paste is smooth and without reliefs. It also has a convexity substantially corresponding to the final one of the cosmetic product.

Of course, it should be said that the surface of the second mold may also have other shapes, such as flat, wavy, with different convexity, depending on the final result to be achieved.

However, it is advantageous that the shape of the second mold, in that area intended to press the cosmetic paste, corresponds to that of the first hot mold, except for the reliefs. In fact, the rough shape of the base cosmetic product is defined by the first mold in those areas not affected by the reliefs.

The semi-finished product produced following the steps described above is then dried. In particular, the drying takes place in a furnace at a temperature in the range between 30° and 65° C. and for a time between 6 and 24 h.

In any case, irrespective of the technique used for drying, it is advantageous that it continues until a residual amount of solvent (that in the base and in the decorative paste, preferably water) of less than 1.5% by weight is contained in the semi-finished product.

The last step provides for the dried semi-finished product to be worked up to removing the decorative cosmetic paste at least from those areas of the base cosmetic paste free from grooves, so as to expose them.

Such a working may take place in a conventional manner by mechanical removal of at least one of the surface part of the base and decorative cosmetic paste, such as through rubbing with an abrasive sponge.

Alternatively, the surface working may be a turning process, which allows removing the part to be removed in a dry and firm manner, thus preventing the colors from blending together and thus improving still further the definition of the finished product.

In this way, the grooves filled with decorative paste are well defined on the surface of the cosmetic product for make-up, which make the cosmetic product very appealing.

The shape and the arrangement of the reliefs on the mold (and thus that of the grooves, and thus of the decorations) may be of any type. By way of example, FIGS. 10 and 11 show alternative patterns that may be made on the final cosmetic product.

Various embodiments of the invention have been described but others may be conceived using the same innovative concept.

1. A production method of a cosmetic make-up product comprising the steps of:
a. dispensing a base cosmetic paste on a support;
b. pressing the base paste through a first mold heated at a temperature higher than 60° C. and provided with at least one relief adapted to create a groove in the base paste;
c. dispensing a second decorative cosmetic paste over the base cosmetic paste so as to completely cover it and so as to fill at least partially the groove created in the base cosmetic paste by the mold;
d. pressing with a second mold the base cosmetic paste and the decorative cosmetic paste so as to make the pastes take a shape of the second mold, thus obtaining a semi-finished product;
e. drying the semi-finished product;
f. surface working the dried semi-finished product so as to remove the decorative cosmetic paste at least from those areas of the base cosmetic paste free from grooves.

2. A method according to claim 1, wherein the base cosmetic paste has a dynamic viscosity in the range between 800,000 and 1,500,000 cP measured at 25° C. and/or wherein the decorative cosmetic paste has a viscosity in the range between 300,000 and 500,000 cP measured at 25° C.

3. A method according to claim 1, wherein the first mold temperature is in the range between 90° C. and 120° C.

4. A method according to claim 1, wherein the height of the reliefs of the first mold is in the range between 1 and 4 mm, preferably 2.7 mm.

5. A method according to claim 1, wherein the pressing with the first heated mold and/or with the second mold takes place by interposing a canvas.

6. A method according to claim 1, wherein the second mold is free from reliefs.

7. A method according to claim 1, wherein the drying takes place in a furnace at a temperature in the range between 30 and 65° C. and for a time between 6 and 24 h.

8. A method according to claim 1, wherein the base cosmetic paste and decorative paste comprise a volatile solvent and the drying lasts until the residual amount of volatile solvent in the semi-finished product is less than 1.5% by weight.

9. A method according to claim 1, wherein the surface working takes place by mechanical removal of the surface part at least one among the base cosmetic paste and the decorative cosmetic paste and wherein the surface working is a turning process.
